(19) United States
(12) Patent Application Publication
(10) Pub. No.: US 2026/0328972 A1
(43) Pub. Date: Oct. 22, 2026

(54) OPTICAL COUPLING SYSTEMS AND METHODS FOR MANUFACTURING SAME

(71) Applicant: University of Delaware, Newark, DE (US)

(72) Inventors: Tingyi GU, Newark, DE (US); Mark MIROTZNIK, Newark, DE (US); Ellen GUPTA, Newark, DE (US); Masudur RAHIM, Newark, DE (US); Haixin ZHAO, Newark, DE (US)

(73) Assignee: University of Delaware, Newark, DE (US)

(21) Appl. No.: 19/486,155

(22) PCT Filed: May 24, 2024
(86) PCT No.: PCT/US2024/030951

§ 371 Date: Nov. 20, 2025

Related U.S. Application Data
(60) Provisional application No. 63/504,000, filed on May 24, 2023.

(51) Int. Cl. G02B 3/00

(52) U.S. Cl. CPC G02B 3/0056; G02B 3/0012

(57) ABSTRACT

Semiconductor chips including microlens arrays, and methods for forming microlens arrays, are disclosed. A semiconductor chip includes at least one optical coupler and a microlens array. The at least one optical coupler is formed on a surface of the semiconductor chip. The microlens array is formed on the surface of the semiconductor chip covering the at least one optical coupler. A method for forming a microlens array includes identifying a location of at least one optical coupler on a surface of a semiconductor chip, dispensing optical material on the surface of the semiconductor chip at the location of the at least one optical coupler in a shape of a microlens array, and curing the optical material to form the microlens array.

### CROSS-REFERENCE TO RELATED APPLICATIONS

The present application claims priority to U.S. Patent Application No. 63/504,000, entitled “Micro-Dispensing Packaging Scheme for Wafer-Scale Integrated Photonic Vertical Coupler Arrays,” filed May 24, 2023, the contents of which are incorporated herein by reference in their entirety.

### STATEMENT REGARDING FEDERALLY SPONSORED RESEARCH

This invention was made with government support under Grant No. N660012114034 awarded by the Defense Advanced Research Projects Agency. The government has certain rights in the invention.

### TECHNICAL FIELD

The present invention relates generally to optical coupling structures, and more particularly, to methods for chip-scale and wafer-scale integration of free-space optical coupling structures.

### BACKGROUND

Conventional photonic semiconductor chips can include optical couplers on the edges or surfaces thereof. One group of optical couplers, free-space optical couplers, work by transmitting propagating light waves from wave guides on the semiconductor chip into free-space, and vice versa. These types of couplers may be limited by a narrow field of view in which they are able to efficiently couple free-space optical signals, resulting in lower overall coupling efficiency or insertion loss. To improve coupling efficiency of surface optical couplers, optical elements such as prisms and/or lenses may be used to redirect, collimate, or focus inbound or outbound light. However, these additional structures can may complicate the design or manufacture of optical coupling systems, resulting in increased costs and/or decreased reliability or yield.

### SUMMARY

Aspects of the present invention are directed to semiconductor chips including microlens arrays, and methods for forming microlens arrays.

In one aspect, a semiconductor chip includes at least one optical coupler and a microlens array. The at least one optical coupler is formed on a surface of the semiconductor chip. The microlens array is formed on the surface of the semiconductor chip covering the at least one optical coupler.

In another aspect, a method for forming a microlens array includes identifying a location of at least one optical coupler on a surface of a semiconductor chip, dispensing optical material on the surface of the semiconductor chip at the location of the at least one optical coupler in a shape of a microlens array, and curing the optical material to form the microlens array.

### BRIEF DESCRIPTION OF THE DRAWINGS

Aspects of the invention may be best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be omitted. In addition, according to common practice, the various features of the drawings are not drawn to scale unless otherwise indicated, and the dimensions of the various features may be expanded or reduced for clarity. Included in the drawings are the following figures:

FIG. 1 is a block diagram of an example method for forming a microlens array.

FIG. 2 is a block diagram of an example system for forming a microlens array.

FIGS. 3A and 3B are block diagrams of an example semiconductor chip including a microlens array.

FIGS. 4A-4C are microscopic images of example microlens arrays.

### DETAILED DESCRIPTION

The systems, methods, and devices disclosed herein are suitable for use in manufacturing and producing integrated photonic circuits. Integrated photonics implement complex photonic systems in small chips or chiplets, including optical trapping, biosensing, quantum optics, and optical phase arrays for free-space beam steering. As the critical on/off-chip interface, many efforts have been dedicated to improving the performance of optical couplers. The disclosed examples are capable of achieving near unity coupling efficiency in association with grating couplers, simultaneously achieving a desired beam shape, low insertion loss, and target operation wavelength.

The disclosed examples may be suitable for improving existing manufacturing processes for these circuits, e.g. from the standpoints of costs, reliability, yield, or throughput. The disclosed examples may further result in photonic semiconductor chips having wider fields of view, higher coupling efficiencies, or lower insertion loss, for example. These examples may improve on conventional photonic chips by enabling faster or easier signal transfer or communication.

The disclosed examples may have applications in a number of fields including, for example, photonics, optical or photonic computing, remote sensing, surface imaging, LIDAR, etc. Other applications for the discloses systems and methods will be apparent from the description herein.

In one example, a manufacturing method enables production of a sub-second, flawless, surface tension-driven spherical shape in the form of a dielectric dot which functions as a self-assembled microlens. Combined with dispersive nanophotonic structures defined on a semiconductor substrate, the disclosed micro-dispensed dielectric microlenses create an angular field distribution for the vertically coupled nanostructures. The microlenses improve the angular tolerance for photonic input and reduce the angular spreading of photonic output in the far field. The micro-dispensing is fast, scalable, and back-end-of-line compatible, for easy fixing the geometric offset caused efficiency reductions and center wavelength drift. Less than 1 dB difference between 7° and 14° incident angles has been observed in grating couplers included the microlenses described herein, in comparison to reference grating couplers which may show around 5 dB contrast.

Additional advantages of the disclosed examples will be apparent from the description herein.

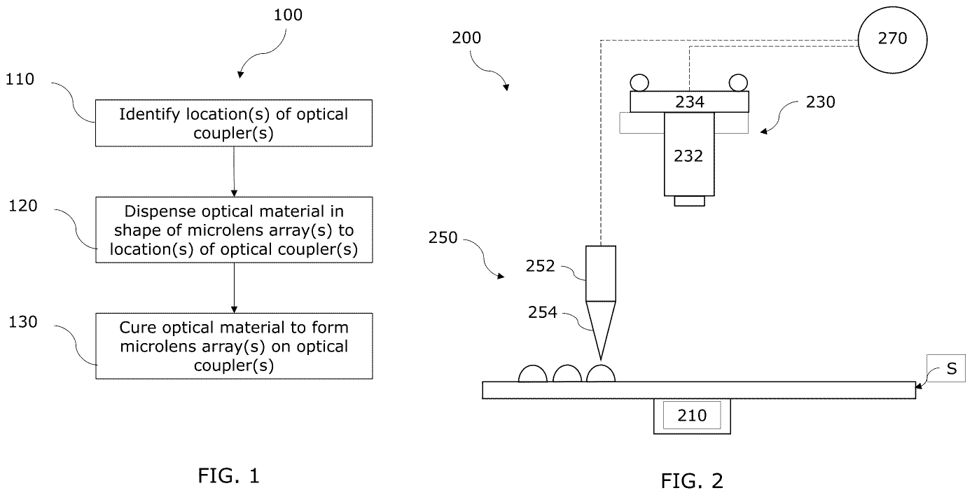

With reference to the drawings, FIG. 1 illustrates an example method 100 for forming a microlens array. Method 100 may be especially adapted for integration with the manufacture of photonic integrated circuits. As an example, method 100 includes identifying a coupler location, dispensing optical material, and curing the optical material. Additional details of method 100 are set forth below.

In step 110, a coupler location is identified. A semiconductor chip having surface optical couplers may be examined to identify the location of at least one optical coupler on the surface of the semiconductor chip. In some examples, the semiconductor chip may have multiple optical couplers on a surface thereof, with the location of each such coupler being identified. In some examples, the optical coupler will be a grating coupler. However, other optical couplers, including surface-mounted optical couplers and edge couplers, are envisioned within the scope of the invention.

In one example, the location of optical couplers on the semiconductor chip may be identified automatically. In this example, an imaging system may be provided for acquiring an image of the surface of the semiconductor chip. The acquired image may then be processed to automatically identify the location of the optical couplers from the image. Suitable processing algorithms may employ known image recognition and/or edge detection techniques to identify the appearance of optical couplers in the acquired image. Other algorithms for automatically identifying the locations of optical couplers in an image of the surface of the semiconductor chip will be apparent from the description herein.

In another example, the location of optical couplers on the semiconductor chip may be predetermined in advance from the plan or design of the semiconductor chip. In this example, the plan or design of the chip may be acquired, with the locations of the optical couplers on the surface predetermined. The identification of the location of the optical couplers in this example may them require nothing more than processing the chip plan or design to locate the positions of the optical couplers.

In step 120, optical material is dispensed to the semiconductor chip. In some examples, the optical material is dispensed or applied directly onto the surface of the semiconductor chip at the locations of the optical couplers. The optical material may be dispensed, for example, using one or a series of micro-dispenser nozzles. The micro-dispenser nozzles may be components of or repurposed from a three-dimensional printing system, or may be specially designed to dispense the optical material of the described examples.

The optical material is dispensed on the surface of the semiconductor chip in a shape of a microlens array, i.e., a group or series of microlenses. The microlens array may be formed to partially or entirely cover the underlying optical coupler. The microlens array may or may not be aligned with the underlying optical coupler, so long as it covers a sufficient portion of the coupler structure. In some examples, each microlens can be formed as a semi-spherical or ovoid bump or projection on the surface of the semiconductor chip. In other examples, microlenses can take other shapes, such as cylindrical lines or ridges. The optical material may be dispensed in one or multiple droplets to form each microlens. Each microlens in the array may be formed simultaneously through multiple dispensers, or may be formed individually by a single common dispenser.

The optical material dispensed to the semiconductor chip may be selected based on the optical properties of the material for the light to be coupled by the underlying optical coupler. For example, the optical material may be selected based on a desired index of refraction, or based on a desired size and shape of the lens, which may be dictated by a surface tension or flowability of the material. Suitable materials for use as the optical material include optically clear adhesives or resins having suitable flowability and viscosity for retaining the microlens shape prior to curing, and include ultraviolet curing optical adhesives provided by Norland Products Inc.

In some examples, the dispensing of the optical material may be performed in conjunction with the use of an imaging system for the semiconductor chip. In one example, an image of the surface of the semiconductor chip is acquired, and locations of the optical couplers on the surface of the semiconductor chip are automatically identified and the coordinates stored. In a further step, micro-dispensers for dispensing the optical material may be automatically moved to the coordinates of the optical couplers identified in the image. Once they reach the identified location, the micro-dispensers can be actuated to automatically dispense the optical material in the shape of the microlens array at the location of the optical coupler.

It will be understood that the shape of the microlens array, or of microlenses therein, may be selected or controlled to promote coverage, coupling efficiency, field of view, or other factors for each optical coupler on the semiconductor chip. Accordingly, step 120 may further include steps relating to the selection, adjustment, or control of the shape of the microlens array, or of individual microlenses in the microlens array.

In some examples, a size or shape of the microlens array may be adjusted based on the location of the optical coupler. For one example, in areas of the semiconductor chip where the optical coupler is free from surrounding components, the size of the microlens array may be maximized to promote coupling light into the optical coupler. For another example, in areas of the semiconductor chip in which there are a number of neighboring components, the shape of the microlens array may be adjusted to accommodate such components. Other factors affecting the size or shape of the microlens array will be apparent from the description herein.

In some examples, a shape of microlenses in the microlens array may be selected based on a desired performance of the microlens array. For one example, the dispensing system may include a controller and memory which store a plurality of different shapes of microlenses, e.g. spherical, cylindrical, annular, etc. A desired shape of microlenses may be selected from this plurality of stored microlens shapes, e.g. based on the type of function of optical coupler. Once selected, the optical material may be dispensed in the selected shape for the microlens.

A controller of the dispensing system may control a number of different variables during the dispensing process in order to form or optimize the shape of the microlens array being formed with the optical material. In one example, the controller or a user may select a micro-dispenser nozzle from among a plurality of micro-dispenser nozzle options based on the selected shape of the microlenses in the microlens array. The nozzle options may include nozzles with differently sized openings, e.g. for use in forming microlenses of different sizes. In another example, the controller or a user may select a nozzle size based on the selected shape of the microlenses in the microlens array, and/or based on a viscosity of the optical material. Larger nozzle sizes may be preferred for optical material having a higher viscosity. In yet another example, the controller or a user may select a dispensing time, or a volume of optical material to be dispensed, based on the selected shape of the microlenses in the microlens array. Longer dispensing times or larger dispensing volumes may be used for larger spherical lenses, or for cylindrical or annular lens shapes.

It will be understood that the invention is not limited to using micro-dispensers to dispense optical material, and other known structures could be used to apply the optical material to the surface of the semiconductor chip. In one alternative example, an ink-jet process may be used for applying optical material to the semiconductor chip. Ink-jet processes may be particularly suited for forming microlenses from optical materials having a lower viscosity, and/or for forming relatively smaller microlenses. As such, the process for forming the microlens arrays may be selected based on the size of the microlenses in the arrays. In addition to micro-dispensing nozzles and ink-jets, other suitable processes will be apparent from the description herein.

In step 130, optical material is cured. The optical material may be cured to set the optical material in its current shape, and thereby form the microlens array. The type and length of curing may be selected based on the optical material used. In some examples, the optical material may be cured using ultra-violet (UV) light for a period of twenty to thirty minutes or more.

FIG. 2 illustrates an example system 200 for forming a microlens array. System 200 may be especially adapted for performing method 100, e.g. for manufacturing photonic integrated circuits. As an example, system 200 includes a substrate holder 210, an imaging system 230, a dispenser 250, and a controller 270. Additional details of system 200 are set forth below.

Substrate holder 210 is configured to hold a semiconductor chip or wafer S. In some examples, substrate holder 210 may be associated with a semiconductor wafer manufacturing process. Substrate holder 210 may be configured to receive or convey a semiconductor wafer prior to dicing. Substrate holder 210 is configured to hold the semiconductor wafer or chip such that an upper surface thereof is unobstructed. Suitable conveyers and holders for use as substrate holder 210 will be apparent from the description herein.

Imaging system 230 is configured to acquire an image of a surface of the semiconductor chip or wafer held by substrate holder 210. Imaging system 230 includes at least one camera 232 oriented facing the substrate holder 210. In one example, imaging system 230 may have a field of view sufficient to image an entire surface of the semiconductor chip or wafer held by substrate holder 210. In another example, camera 232 may be mounted to a mobile vehicle 234 in order to scan camera 232 across the surface of the semiconductor chip or wafer, and thereby acquire an image of the chip or wafer. Suitable cameras for use as camera 232 will be known from the description herein.

Dispenser 250 is configured to dispense optical material onto the semiconductor chip or wafer. In some examples, dispenser comprises one or more micro-dispensers configured to dispense optical material at the locations of optical couplers on the semiconductor chip or wafer. Suitable micro-dispensers for use as dispenser 250 include the micro-dispenser and/or three-dimensional printing products provided by nScrypt Inc.

Dispenser 250 may include one or more reservoirs 252 of optical material to be dispensed in communication with one or more nozzles 254 for dispensing the optical material. Reservoirs 252 may be opaque or blocked from light sources, in order to preserve the optical properties and flowability of the optical material prior to curing. In some examples, dispenser 250 may include a piston/cylinder arrangement in order to dispense optical material from the reservoir. In other examples, dispenser 250 may include a pump which can be actuated to pump optical material onto the semiconductor chip or wafer.

Controller 270 is configured to control the components of system 200 to form a microlens array on a semiconductor wafer or chip held by substrate holder 210. Controller 270 may comprise one or more microprocessors in communication with memory on which are stored instructions for performing steps for forming a microlens array. In particular, controller 270 may be programmed to perform any of the steps of functions set forth above with respect to method 100. Examples of particular functions performed by controller 270 are set forth below.

Controller 270 may be configured to use imaging system 230 to acquire an image of the surface of the semiconductor wafer or chip, and automatically identify the locations of optical couplers in that image. Controller 270 may then store coordinates corresponding to locations of the optical couplers, and use those coordinates to control dispenser 250 to dispense optical material at the coordinates of the optical couplers. Controller 270 may use imaging system 230 to confirm correct positioning (in three dimensions) prior to dispensing. Controller 270 may further use the acquired image of the semiconductor wafer to select a size or shape of the microlens array formed by dispenser 250, e.g., based on the shape or size of the optical coupler, and/or based on the proximity of other components to the optical coupler.

In addition to controlling the shape and size of the microlens array, controller 270 may control the shape and size of individual microlenses of the microlens array. Controller 270 may control the volume of optical material dispensed during dispensing, e.g., by controlling a pump pressure applied to the optical material, or by controlling opening and closing times of a nozzle of the micro-dispenser. Controller 270 may further control the position or movement of dispenser 250 before or during dispensing, e.g., to change the shape of the microlens by causing movement of the dispenser during dispensing.

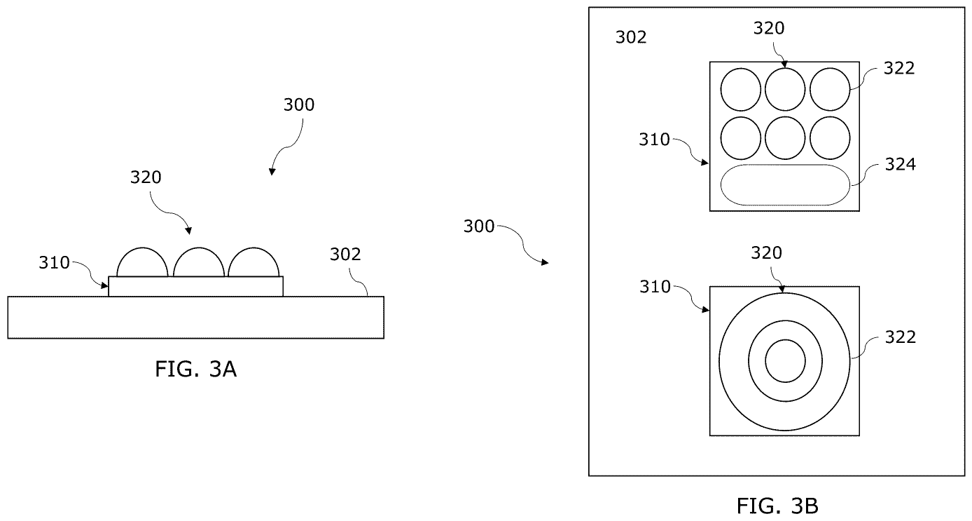

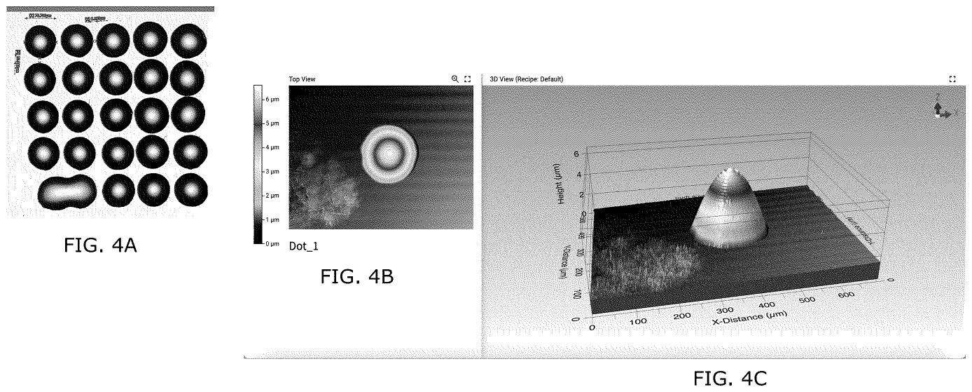

FIGS. 3A and 3B illustrate an example semiconductor chip 300. Chip 300 may be manufactured using method 100 using system 200. As an example, chip 300 includes at least one optical coupler 310 and a microlens array 320. Additional details of chip 300 are set forth below.

Optical coupler 310 is formed on a surface 302 of semiconductor chip 300. Optical coupler 310 is configured to couple light between a waveguide on chip 300 and free-space. Semiconductor chip 300 may include one or a plurality of optical couplers 310. Suitable components for use as optical couplers 310 include, for example, grating couplers. Other suitable couplers will be known from the description herein.

Microlens array 320 is formed on the surface 302 of the semiconductor chip 300 covering the optical coupler 310. Microlens array 320 is designed to improve the optical efficiency or field of view of optical coupler 310, e.g., by redirecting light from free space onto optical coupler 310. As set forth above with respect to method 100, microlens array 320 may be formed from an optically clear resin that has been cured. Where semiconductor chip 300 includes multiple optical couplers 310, it may further include multiple microlens arrays 320 each formed covering a respective one of the optical couplers.

As noted above, the shape of microlens array 320, or the lenses in microlens array 320, may be selected based on a desired performance of the microlens array. In one example, one microlens 322 in a microlens array 320 has a different shape or size than another microlens 324 in the microlens array 320. In other examples, different microlens arrays 320 may have different lenses. For example, one of the plurality of microlens arrays 320 has a different size or shape from another one of the plurality of microlens arrays 320. For another example, one of the plurality of microlens arrays 320 may include microlenses having a different shape than microlenses in another one of the plurality of microlens arrays 320.

The examples described in the present application set forth a micro-dispenser approach for forming microlens arrays that allows high throughput, has a relatively low cost, and is compatible with back-end-of-line processing in silicon photonic foundry manufacturing. The examples include fully automated and high throughput micro-dispenser processes capable of printing on large arrays of grating couplers (typically 105 couplers or more) on an 8-inch wafer within 5.5 hours, compared to two months of continuous writing for direct laser writing. In addition to reducing the insertion loss, the contact-angle-defined numerical aperture of the microlenses can be around 0.36, which expands the angle tolerance of input couplers and suppresses the angular spread of the output beams from the grating coupler in the far field.

Although the invention is illustrated and described herein with reference to specific embodiments, the invention is not intended to be limited to the details shown. Rather, various modifications may be made in the details within the scope and range of equivalents of the claims and without departing from the invention.

1. A semiconductor chip comprising:
at least one optical coupler formed on a surface of the semiconductor chip;
a microlens array formed on the surface of the semiconductor chip covering the at least one optical coupler.

2. The semiconductor chip of claim 1, wherein the at least one optical coupler is a grating coupler.

3. The semiconductor chip of claim 1, wherein the microlens array is formed from a cured optically clear resin.

4. The semiconductor chip of claim 1, wherein one microlens in the microlens array has a different shape or size than another microlens in the microlens array.

5. The semiconductor chip of claim 1, wherein the at least one optical coupler comprises a plurality of optical couplers, and wherein the microlens array comprises a plurality of microlens arrays formed covering respective ones of the plurality of optical couplers.

6. The semiconductor chip of claim 5, wherein one of the plurality of microlens arrays has a different size or shape from another one of the plurality of microlens arrays.

7. The semiconductor chip of claim 5, wherein one of the plurality of microlens arrays includes microlenses having a different shape than microlenses in another one of the plurality of microlens arrays.

8. A method for forming a microlens array comprising:
identifying a location of at least one optical coupler on a surface of a semiconductor chip;
dispensing optical material on the surface of the semiconductor chip at the location of the at least one optical coupler in a shape of a microlens array; and
curing the optical material to form the microlens array.

9. The method of claim 8, wherein the at least one optical coupler is a grating coupler.

10. The method of claim 8, wherein the identifying comprises:
acquiring an image of the surface of the semiconductor chip; and
automatically identifying the location of the at least optical coupler using the image.

11. The method of claim 8, wherein the identifying comprises:
acquiring a predetermined plan or design of the semiconductor chip; and
identifying the location of the at least optical coupler using the plan or design.

12. The method of claim 8, wherein the optical material is an optically clear resin.

13. The method of claim 8, wherein the dispensing comprises dispensing the optical material using one or more micro-dispenser nozzles.

14. The method of claim 13, further comprising:
acquiring an image of the surface of the semiconductor chip; and
automatically moving the one or more micro-dispenser nozzles to the location of the at least one optical coupler using the image.

15. The method of claim 8, wherein the microlens array is formed covering the at least one optical coupler.

16. The method of claim 8, further comprising:
adjusting a size or the shape of the microlens array based on the location of the at least one optical coupler.

17. The method of claim 8, wherein the dispensing comprises:
selecting a shape of microlenses in the microlens array from a plurality of shapes of microlenses; and
dispensing the optical material in the shape of the microlenses in the microlens array.

18. The method of claim 17, further comprising:
selecting a micro-dispenser nozzle type for dispensing the optical material based on the selected shape of microlenses in the microlens array.

19. The method of claim 17, further comprising:
selecting a micro-dispenser nozzle size for dispensing the optical material based on the selected shape of microlenses in the microlens array and a viscosity of the optical material.

20. The method of claim 17, further comprising:
selecting a dispensing time or dispensing volume based on the selected shape of microlenses in the microlens array.
